(19) United States
(12) Patent Application Publication
(10) Pub. No.: US 2017/0161653 A1
(43) Pub. Date: Jun. 8, 2017

(54) METHOD AND SYSTEM FOR EXECUTING PROBLEM SOLVING RULES BY A COGNITIVE AGENT

(71) Applicant: Omprakash Visvanathan, Chennai (IN)

(72) Inventor: Omprakash Visvanathan, Chennai (IN)

(21) Appl. No.: 15/004,609

(22) Filed: Jan. 22, 2016

(30) Foreign Application Priority Data
Dec. 3, 2015 (IN) 6493/CHE/2015

(51) Int. Cl. G06Q 10/06; G06N 5/02; G06F 17/30

(52) U.S. Cl. CPC G06Q 10/067; G06F 17/30958; G06N 5/02

(57) ABSTRACT

The present disclosure relates to a method and system for executing a plurality of business rules. The method includes scanning a plurality of elements added to an input link of an initialized state, writing the scanned plurality of elements to an output link of the initialized state, executing the plurality of business rules based on creation of a state graph, selecting one or more operators for execution and applying actions of productions on an operator of the one or more operators. The state graph is created by adding a plurality of nodes and a plurality of attributes to a top level state. The one or more operators are selected based on a preference of a plurality of preferences in a preference memory. The actions of productions can be applied by adding and removing the plurality of elements.

### CROSS REFERENCE TO RELATED APPLICATIONS

The present application claims priority from Indian patent application number 6493/CHE/2015 filed on 3 Dec. 2015, which is incorporated herein by reference.

### TECHNICAL FIELD

The present invention relates to the field of problem solving rules, and in particular, relates to implementation of a new interface to execute problem solving rules by a cognitive agent.

### BACKGROUND

With an increasing development in the field of artificial intelligence, concept of the cognition has been increasingly used to formulate business structure and business rules. The cognition refers to human facility of thinking and reasoning. Further, the cognition is an ability of problem solving and decision making.

The business rules are intended to control or influence behavior of a business. Further, as the business rules are closely associated with cognitive systems, the business rules intend to support and/or provide cognitive capabilities. The cognitive capabilities include but may not be limited to problem solving, language comprehension, learning, perception and memory. The cognitive systems facilitate decision making such as if and when to perform certain condition based responsive activity, including logistics and maintenance activity in response to a known and/or anticipated condition. Further, the cognitive systems employ various techniques for implementing behavior and decision making capabilities.

In few of the presently available cognitive systems, human intervention takes over to identify, organize, plan and execute a particular maintenance activity for a given platform or set of platforms. Further, the organizing and the execution of certain conditions are not fully efficient to rely upon. Furthermore, the process becomes time consuming.

Existing cognitive systems also have a limitation in that interfacing with such systems is difficult as they are compatible with few programming languages. Moreover, the current cognitive systems have legacy architecture with command line interfacing which is error prone.

In light of the forgoing discussion, there is a need for a method and system that overcomes the above stated disadvantages. Further, there is a need for a method and system that is fully independent of user intervention.

### SUMMARY

In an aspect of the present disclosure, a computer-implemented method is provided. The computer-implemented method includes scanning a plurality of elements added to an input link of an initialized state, writing the scanned plurality of elements to an output link of the initialized state, executing a plurality of business rules based on creation of a state graph, selecting one or more operators for execution and applying actions of production on an operator of the one or more operators. The state is a top level object. The state graph is created by adding a plurality of nodes and a plurality of attributes to a top level state. The one or more operators are selected based on a preference of a plurality of preferences in a preference memory. The preference is an imperative associated with an operator of the one or more operators. The actions of production can be applied by adding and removing an element of the plurality of elements.

In an embodiment of the present disclosure, a library is provided for constructing agent based systems. The library is preferably written in Java code and provides one or more classes and interfaces such as—methods for searching and filtering working memory elements (WME), adding and updating WMEs, event handling patterns etc.

In an embodiment of the present disclosure, the computer-implemented method further includes adding a plurality of elaborations to the state graph. The adding is performed prior to the selecting of the one or more operators for execution.

In an embodiment of the present disclosure, the computer-implemented method further includes updating the state graph. The state graph is updated to reflect a new state of the state graph.

In an embodiment of the present disclosure, each of the plurality of preferences includes a corresponding semantic of a plurality of semantics. The plurality of preferences includes at least one of an acceptable preference, a reject preference, a better/worse preference, a best preference, a worst preference, an indifferent preference, a numeric-indifferent preference, a require preference and a prohibit preference.

In an embodiment of the present disclosure, a plurality of impasses arises from the plurality of preferences. The plurality of impasses includes a tie impasse, a conflict impasse, a constraint-failure impasse and a no-change impasse. The no-change impasse further includes a state no-change impasse and an operator no-change impasse.

In an embodiment of the present disclosure, each of the actions of the production adds the plurality of elements in a working memory. The plurality of elements is added from at least one of a plurality of sources.

In an embodiment of the present disclosure, each of the actions of the production removes the plurality of elements from a working memory. The plurality of elements is removed by at least one of a plurality of removal ways.

In an embodiment of the present disclosure, one or more variables are bound to one or more symbols in the corresponding plurality of elements of a working memory to obtain a production.

In another aspect of the present disclosure, a computer program product including a non-transitory computer readable medium storing a computer readable program is provided. The computer readable program when executed on a computer causes the computer to perform steps including scanning a plurality of elements added to an input link of an initialized state, writing the scanned plurality of elements to an output link of the initialized state, executing a plurality of business rules based on creation of a state graph, selecting one or more operators for execution and applying actions of productions on an operator of the one or more operators. The state is a top level object. The state graph is created by adding a plurality of nodes and a plurality of attributes to a top level state. The one or more operators are selected based on a preference of a plurality of preferences in a preference memory. The preference is an imperative associated with an operator of the one or more operators. The actions of productions can be applied by adding and removing an element of the plurality of elements.

In an embodiment of the present disclosure, the computer readable program when executed on the computer causes the computer to perform a further step of adding a plurality of elaborations to the state graph. The adding is performed prior to the selecting of the one or more operators for execution.

In an embodiment of the present disclosure, the computer readable program when executed on the computer causes the computer to perform a further step of updating the state graph. The state graph is updated to reflect a new state of the state graph.

In an embodiment of the present disclosure, each of the plurality of preferences includes a corresponding semantic of a plurality of semantics. The plurality of preferences includes at least one of an acceptable preference, a reject preference, a better/worse preference, a best preference, a worst preference, an indifferent preference, a numeric-indifferent preference, a require preference and a prohibit preference.

In an embodiment of the present disclosure, a plurality of impasses arises from the plurality of preferences. The plurality of impasses includes a tie impasse, a conflict impasse, a constraint-failure impasse and a no-change impasse. The no-change impasse further includes a state no-change impasse and an operator no-change impasse.

In an embodiment of the present disclosure, each of the actions of the production adds the plurality of elements in a working memory. The plurality of elements is added from at least one of a plurality of sources.

In an embodiment of the present disclosure, each of the actions of the production removes the plurality of elements from a working memory. The plurality of elements is removed by at least one of a plurality of removal ways.

In one embodiment of the present disclosure, an interface is provided to the user for entering commands such as but not limited to input, output, debug, run etc. using one or more programming languages. Further, custom codes are provided for executing the cognitive agent business rules system.

In another embodiment of the present disclosure, the interface is configured to store the objects from the command in a DOM and pass the modified XML strings to the kernel for execution. Further, the XML strings can be passed through a socket or a remote function call.

In yet another aspect of the present disclosure, a cognitive agent business rules system is provided. The cognitive agent business rules system includes a scanning module, a writing module, an executing engine, a selecting engine and an application module. The scanning module scans a plurality of elements added to an input link of an initialized state. The state is a top level object. The writing module writes the scanned plurality of elements to an output link of the initialized state. The executing engine executes a plurality of business rules based on creation of a state graph. The state graph is created by adding a plurality of nodes and a plurality of attributes to a top level state. The selecting engine selects one or more operators for execution. The one or more operators are selected based on a preference of a plurality of preferences in a preference memory. The preference is an imperative associated with an operator of the one or more operators. The application module applies actions of production on an operator of the one or more operators. The actions of production can be applied by adding and removing an element of the plurality of elements.

In an embodiment of the present disclosure, wherein each of the plurality of preferences includes a corresponding semantic of a plurality of semantics. The plurality of preferences includes at least one of an acceptable preference, a reject preference, a better/worse preference, a best preference, a worst preference, an indifferent preference, a numeric-indifferent preference, a require preference and a prohibit preference.

In an embodiment of the present disclosure, a plurality of impasses arises from the plurality of preferences. The plurality of impasses includes a tie impasse, a conflict impasse, a constraint-failure impasse and a no-change impasse. The no-change impasse further includes a state no-change impasse and an operator no-change impasse.

### BRIEF DESCRIPTION OF THE FIGURES

Having thus described the invention in general terms, reference will now be made to the accompanying drawings, which are not necessarily drawn to scale, and wherein:

FIG. 1A illustrates a system for showing interaction of a business rules management system with a communication device, a cloud platform and a data center, in accordance with various embodiments of the present disclosure;

FIG. 1B illustrates an exemplary process flow of using the business rules management system in a basic use case in accordance with embodiments of the present disclosure.

FIG. 1C illustrates an exemplary compound event processing using the business rules management system in accordance with an embodiment of the present disclosure.

FIG. 2 illustrates a system showing an interaction between the business rules management system, an application server and a plurality of users, in accordance with various embodiments of the present disclosure;

FIG. 3 illustrates a block diagram showing transmission of commands to the cognitive agent kernel through an interface in accordance with various embodiments of the present disclosure;

FIG. 4 illustrates another block diagram showing transmission of commands from one or more input terminals to the cognitive agent kernel through an interface in accordance with various embodiments of the present disclosure;

FIG. 5 illustrates a block diagram of a communication device, in accordance with various embodiments of the present disclosure; and

FIG. 6 is a flowchart describing actions of production on one or more operators, in accordance with various embodiments of the present disclosure.

### DETAILED DESCRIPTION

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

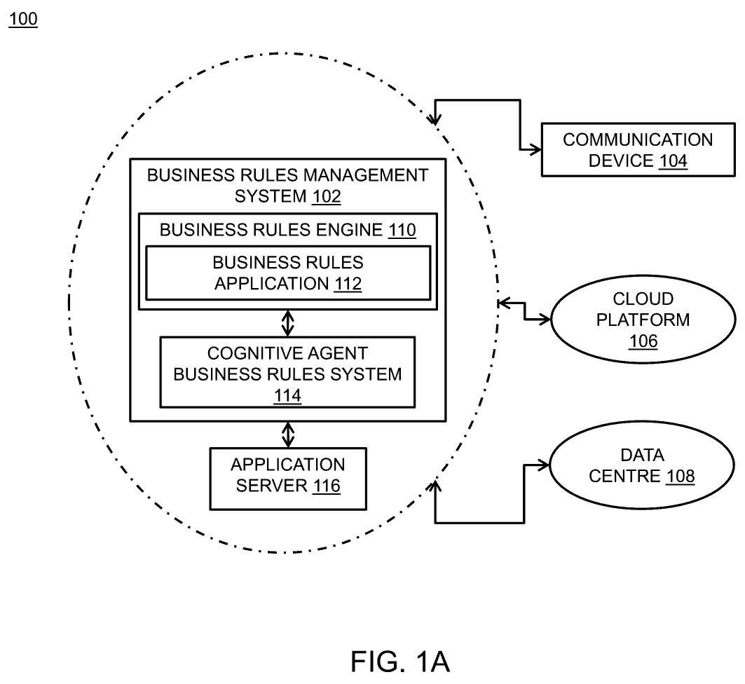

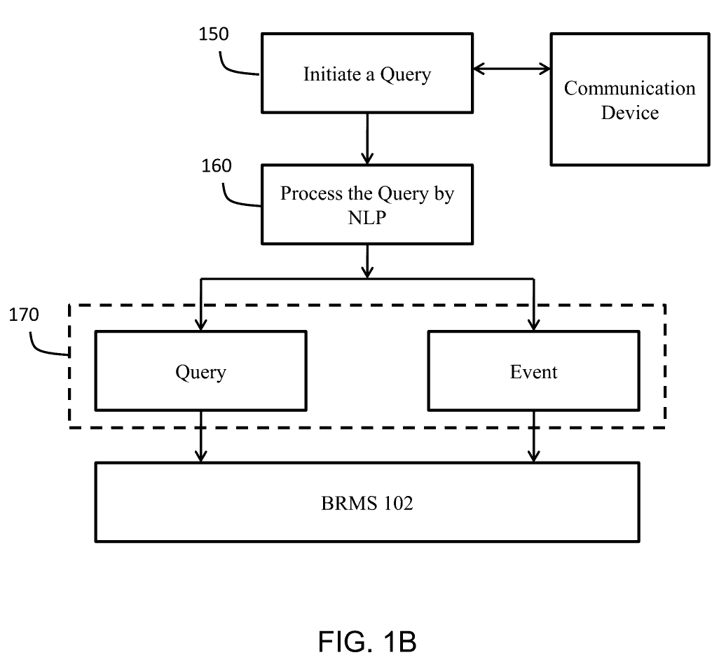

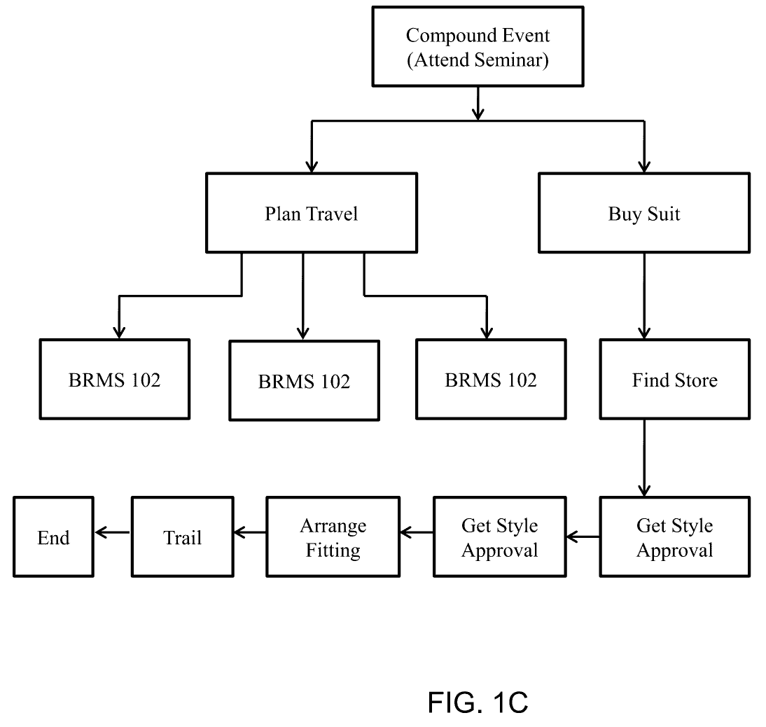

FIG. 1A illustrates a system 100 for showing interaction of a business rules management system 102 with a communication device 104, a cloud platform 106 and a data centre 108, in accordance with various embodiments of the present disclosure. The business rules management system (hereinafter ‘BRMS’) 102 composes business rules and allows individuals and/or users to use its business rules functions. The BRMS 102 hosts a business rules engine 110. Further, the business rules engine 110 hosts a business rules application 112. Essentially, the business rules engine 110 of the BRMS 102 is responsible for composing and managing business rules. Further, the business rules engine 110 is associated with a cognitive agent business rules system 114.

The cognitive agent business rules system 114 emulates and/or supports human cognitive capabilities including problem solving, language comprehension, learning, perception and memory. Further, the cognitive agent business rules system 114 employs various techniques for implementing behavior and decision making capabilities. Further, the BRMS 102 is linked to an application server 116.The application server 116 executes the business rules application 112. The business rules application 112 is available for usage and can be run on the communication device 104, the cloud platform 106 and the data center 108.

It may be noted that in FIG. 1A, the business rules application 112 is run on the communication device 104; however those skilled in the art would appreciate that the business rules application 112 may be run on more communication devices.

As described in detailed description of FIG. 1A, the business rules engine 110 is associated with the cognitive agent business rules system 114. Thus, the business rules application 112 of the business rules engine 110 can run cognitive tasks to solve real world problems. The cognitive agent business rules system 114 manages the cognitive tasks by scanning a plurality of elements added to an input link of an initialized state. Further, the cognitive agent business rules system 114 writes the scanned plurality of elements to an output link of the initialized state. The state initialization is the responsibility of the cognitive agent business rules system 114. Moreover, the cognitive agent business rules system 114 adds the input link to the initialized state. The input link is configured to allow a plurality of users 202 to add one or more elements to a working memory. In simpler terms, the plurality of users 202 can add the one or more elements to the working memory via the input link. Furthermore, the cognitive agent business rules system 114 adds the output link to the initialized state. The output link is configured to allow the plurality of business rules 208 to add the one or more elements to an output memory. The business rules 208 add the one or more elements to the output memory to let each of the plurality of users 202 know of changes or result. Further, the cognitive agent business rules system 114 applies a plurality of operations to the initialized state.

FIG. 1B illustrates an exemplary process flow for the method of operating the business rules application 112 in accordance with an embodiment of the present disclosure. At step 150, a user initiates one or more queries on his/her personal communication device 104. For example, the queries may be initiated through speech using a mobile phone and a speech recognizer. At step 160, a natural language processor executes lexical pars and semantic analysis on natural language sentences identified by the speech recognizer. Following the processing step, the each identified query and associated events are passed to the cognitive agent business rules system 114 of the BRMS 102 as shown at step 170. The identified queries and events are processed by the cognitive agent business rules system 114 of the BRMS 102 by identifying and executing plurality APIs associated with each event. In one embodiment of the present disclosure, the cognitive agent business rules system 114 comprises Soar components to handle one or more events. The Soar component handles one or more events by utilizing the SoarEventManager and SoarEventListner interfaces.

In an example, a user inputs a query such as “place order for 2 tickets for Sunday's game” and the NLP component (at step 150 as above) identifies quires as “booking 2 tickets” and the event is “Sunday's game”. Accordingly, the cognitive agent business rules system 114 of the BRMS 102 searches for the “Sunday's game” API, sends the query “book 2 tickets” and which is processed accordingly. Similarly, a complex query may be “placing a purchase order for 1000 3D printers” which involves a plurality of lateral events requires identifying and triggering APIs from each of the one or more entities involved such as sales, purchase, accounts departments and also vendor APIs from vendors making 3D printers.

In one embodiment of the present disclosure, the BRMS 102 utilizes statistical tools (for example PERT CPM) to prioritize the queries and events and to process accordingly. FIG. 1C illustrates an example compound event processing in accordance with an embodiment of the present disclosure. As shown, an example compound event “Attend a Seminar” may include two sub-events “Plan Travel” and “Buy Suit” and order in which each events are executed in shown. The manner in which the BRMS 102 functions to execute various queries is described in detail further below.

Generally, the state is a top level object that refers to a psychology concept of state of being. For example, every object is in some state including stationary, moving, sitting, standing and the like. Also, when a sitting object stands, its state changes from sitting to standing.

Further, the cognitive agent business rules system 114 executes a plurality of business rules based on creation of a state graph. In an embodiment of the present disclosure, the cognitive agent business rules system 114 creates the state graph. The state graph is a graph created by adding a plurality of nodes and a plurality of attributes to a top level state. Further, the state graph is a graphical representation of the plurality of nodes and the plurality of attributes. Furthermore, the cognitive agent business rules system 114 executes the plurality of business rules 208 based on the adding of the plurality of nodes and the plurality of attributes to the top level state. The plurality of business rules are composed and formulated by the business rules engine 110.The one or more operators run and make changes to the state or the output link causing more rules of the plurality of business rules 208 to execute.

In an embodiment of the present disclosure, the cognitive agent business rules system 114 represents the current problem-solving situation in the working memory. Thus, the working memory holds the current state and the one or more operators and is a short-term knowledge, that reflects the current knowledge of the world and status in the problem solving. The one or more elements in the working memory are referred to as working memory elements (hereinafter‘WME’). Each WME contains a very specific piece of information. Several WME's collectively may provide more information about a same object. These WME's are related as these WME's are all contributing to a description of something that is internally known to the cognitive agent business rules system 114 as “B1”. Further, the B1 is referred to as an identifier and a group of WME's that share this identifier are referred to as the object in the working memory. In cognitive agent business rules system 114, the objects in the working memory are linked to other objects. Further, value of one WME may be an identifier of another object. In the cognitive agent business rules system 114, all objects in the working memory must be linked to the state, either directly or indirectly (through other objects).Further, objects that are not linked to the state will be automatically removed from the working memory by the architecture of the cognitive agent business rules system 114.

In one embodiment of the present disclosure, the cognitive business rules system 114 utilizes a Soar component (Also referred to as ‘Soar agent’). Soar is a general cognitive architecture for developing systems that exhibit intelligent behavior. Further, JSoar is the Soar agent implemented entirely in Java. The JSoar provides Idiomatic Java API in contrast to CSoar's SWIG-generated bindings, free multi-language support (JRuby, Jython, Rhino (JavaScript), Groovy, Scala, Clojure, and the like), cleaner integration with enterprisey systems, a codebase and tools that more friendly to rapid research prototyping and no native libraries to deal with.

The architecture and working of the cognitive agent business rules system 114 will now be described with references to the various features of the Soar agent that are implemented on the cognitive agent business rules system 114. In order to process the user generated queries received from the communication device 104, the cognitive agent business rules system 114 has to perform one or more functions before applying one or more operations to the initialized state. As discussed before, the various functions of the cognitive agent business rules system 114 is illustrated herein by using Java implementation of the Soar agent, unless otherwise specified.

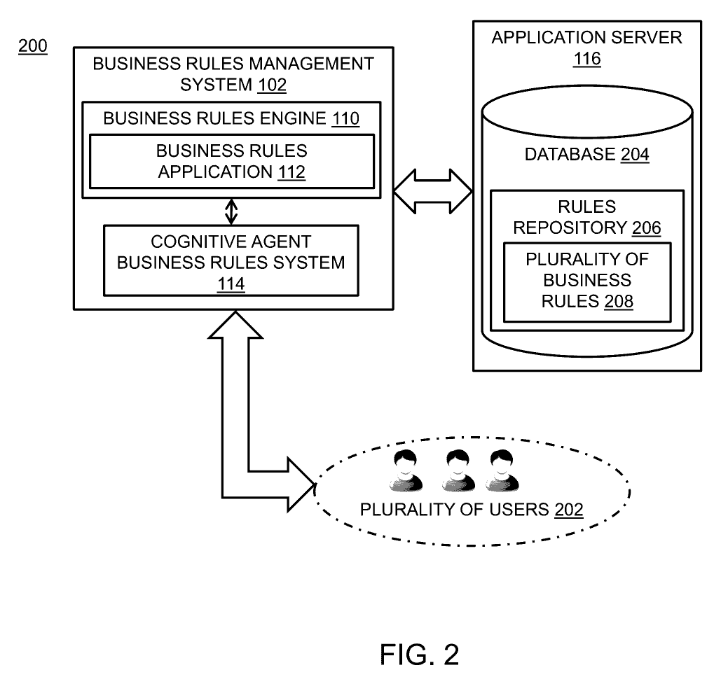

FIG. 2 illustrates a system 200 showing an interaction between the BRMS 102, an application server 116 and a plurality of users 202, in accordance with various embodiments of the present disclosure. The application server 116 includes a database 204. The database 204 stores a rules repository 206. Further, the rules repository 204 stores a plurality of business rules 208.

In addition, the cognitive agent business rules system 114 adds a plurality of elaborations to the state graph. Further, the cognitive agent business rules system 114 selects one or more operators for execution. The one or more operators are selected based on a preference of a plurality of preferences in a preference memory (described later). The preference is an imperative associated with an operator of one or more operators (described later). Furthermore, the cognitive agent business rules system 114 applies actions of productions on the operator of the one or more operators. The actions of productions can be applied by adding and removing the elements (described later).The plurality of preferences persists only as long as the production instantiation that created the plurality of preferences continues to match. When the production instantiation no longer matches, a preference of the plurality of preference is no longer relevant. Further, in this case, the cognitive agent business rules system 114 automatically removes the preference. The plurality of preferences has an I-support (for instantiation support). In an embodiment, the state elaborations are simple inferences that are valid only so long as the production matches. In addition, the cognitive agent business rules system 114 updates the state graph. The state graph is updated to reflect a new state of the state graph.

In an embodiment, the cognitive agent business rules system 114 uses a two stage process to the one or more operators. The cognitive agent business rules system 114 proposes the one or more operators to run. The cognitive agent business rules system 114 selects a correct operator of the one or more operators to run and applies changes. In this way, a best operator for a given situation can be selected from the one or more operators. Moreover, the cognitive agent business rules system 114 displays the selected operator. For example, in a maze program, a robot could encounter 3 paths Left, straight ahead or right ahead of it and must decide which path to choose for which 3 operators are proposed. Further, the cognitive agent business rules system 114proposes the correct operator with a preference strategy. The cognitive agent business rules system 114, then, selects the correct operator and applies it.

Further, in the cognitive agent business rules system 114, one or more variables are bound to one or more symbols in the corresponding one or more elements of the working memory to obtain a production. Furthermore, the binding is performed by a matching process. The production along with a specific and consistent set of variable bindings is referred to as an instantiation. The production instantiations are consistent as every occurrence of a variable is bound to the same value. In an embodiment of the present disclosure, in the cognitive agent business rules system 114, several instantiations of same production may be matched at a same time and, therefore, fired at the same time.

In an embodiment of the present disclosure, in the cognitive agent business rules system 114, the actions of the production add the one or more elements in the working memory. The one or more elements are added from at least one of a plurality of sources (described later). In another embodiment of the present disclosure, in the cognitive agent business rules system 114, the actions of the production remove the one or more elements from the working memory. The one or more elements are removed from at least one of a plurality of removal ways (described later). In the cognitive agent business rules system 114, the actions of the productions that apply to an operator of the one or more operators, either by adding or removing the one or more elements from the working memory, persist even after the operator is no longer selected and operator application production instantiation no longer matches.

Further, in the cognitive agent business rules system 114, the selection of the current operator is determined by the plurality of preferences in a preference memory (as illustrated above). Each of the plurality of preferences is a suggestion or an imperative about a current operator, or information about how suggested operators compare to other operators. Furthermore, each of the plurality of preferences refers to the one or more operators by using the identifier of the one or more elements of the working memory that stands for the operator. After preferences have been created for the state, a decision procedure evaluates the created preferences to select the current operator for that state.

Furthermore, each of the plurality of preferences includes a corresponding semantic of a plurality of semantics. Moreover, the plurality of preferences includes at least one of an acceptable preference, a reject preference, a better/worse preference, a best preference, a worst preference, an indifferent preference, a numeric-indifferent preference, a require preference and a prohibit preference. The plurality of semantics for each of the plurality of preferences is described below.

A semantic for the acceptable preference is Acceptable (+). The acceptable preference states that a value is a candidate for a selection. A semantic for the reject preference is Reject (−). The reject preference states that the value is not a candidate for a selection. A semantic for the better/worse preference is Better (>), Worse (<). The better/worse preference states, for a two values involved, that one value should not be selected if the other value is a candidate. A semantic for the best preference is Best (>). The best preference states that a value may be better than any competing value. A semantic for the worst preference is Worst (<). The worst preference states that a value should be selected only if there are no alternatives. A semantic for the indifferent preference is Indifferent (=). The indifferent preference states that there is a positive knowledge that it does not matter which value is selected. A semantic for the numeric-indifferent preference is Numeric-Indifferent: (=number). The numeric-indifferent preference is used to bias a random selection from mutually indifferent values. A semantic for the require preference is Require (!). The require preference states that a value must be selected if a goal is to be achieved. A semantic for the prohibit preference is Prohibit (˜). The prohibit preference states that a value cannot be selected if a goal is to be achieved.

In the cognitive agent business rules system 114, when the preference of the plurality of preferences in the preference memory cannot be resolved unambiguously, the cognitive agent business rules system 114 reaches an impasse. Further, when the cognitive agent business rules system 114 is unable to select a new operator (in the decision cycle), it is said to reach an operator impasse. In the cognitive agent business rules system 114, all the impasses appear as the states in the working memory, where the states can be tested by productions.

In the cognitive agent business rules system 114, a plurality of impasses arises from the plurality of preferences. In an embodiment of the present disclosure, the plurality of impasses is four in number. The plurality of impasses includes a tie impasse, a conflict impasse, a constraint-failure impasse and a no-change impasse. Further, the no-change impasse comprises a state no-change impasse and an operator no-change impasse. The tie impasse arises if the preference of the plurality of preferences does not distinguish between two or more operators with acceptable preferences. The conflict impasse arises if at least two values have conflicting better or worse preferences (for example, A is better than B and B is better than A) for an operator, and neither one is rejected, prohibited, or required. The constraint-failure impasse arises if there is more than one required value for an operator, or if a value has both a ‘require’ and a ‘prohibit’ preference. The no-change impasse arises if a new operator is not selected during a decision procedure. Further, there are two types of no-change impasse. The first is the state no-change impasse which occurs when there are no acceptable (or require) preferences to suggest operators for the current state (or all the acceptable values have also been rejected). The decision procedure cannot select a new operator. The second is the operator no-change impasse which occurs when either a new operator is selected for the current state but no additional productions match during the application phase, or a new operator is not selected during the next decision phase. In an embodiment, there can be only one type of impasse at a given level of sub-goaling at a time.

The cognitive agent business rules system 114 handles the plurality of impasses by creating a new state in which a goal of the problem solving is to resolve the impasse of the plurality of impasses. Thus, in a sub-state, the one or more operators are selected and applied in an attempt either to discover which of the tied operators should be selected, or to apply the selected operator piece by piece. The sub-state is often referred to as a sub-goal because it exists to resolve the impasse of the plurality of impasses. However, it sometimes referred to a sub-state because representation of the sub-goal is referred as the state.

In the cognitive agent business rules system 114, the sub-goals created to resolve the plurality of impasses generate results that allow the problem solving at higher levels to proceed. Results of the sub-goal are the working memory elements and the plurality of preferences that were created in the sub-state, and that are linked directly or indirectly to a super-state (any super-state in the stack). Architecture of the cognitive agent business rules system 114 automatically detects if the preference or the one or more elements of the working memory created in the sub-state is linked to the super-state. In cognitive agent business rules system 114, the one or more elements of the working memory and the plurality of preferences will not be removed when the impasse of the plurality of impasses is resolved as it is still linked to a super-state, and therefore are the results of the sub-goal. The cognitive agent business rules system 114 decides if a result has either I-support or O-support as follows:

In an embodiment of the present disclosure, a one or more element of the working memory or the preference of the plurality of preferences will be a result if its identifier is already linked to a super-state. In another embodiment of the present disclosure, a one or more element of the working memory or the preference of the plurality of preferences will be a result indirectly if, after it is created and still in the working memory or the preference memory, its identifier becomes linked to a super-state through a creation of another result.

In an embodiment of the present disclosure, for determining whether the result receives the I-support or the O-support, the cognitive agent business rules system 114 determines the function that the one or more element of the working memory or the preference of the plurality of preferences plays. In simpler terms, it determines whether the result should be considered an operator application or not). To do this, the cognitive agent business rules system 114 creates a temporary production, referred to as a justification. The justification summarizes the processing in the sub-state that led to the result.

Further, conditions of the justification are the one or more elements of the working memory that exist in the super-state (and above) and that were necessary for producing the result. This is determined by collecting the one or more elements of the working memory that were tested by the productions and fired in the sub-goal that led to creation of the result, and then removing the conditions that test working memory elements created in the sub-goal. The action of the justification is the result of the sub-goal.

In an embodiment, the cognitive agent business rules system 114 determines the I-support or the O-support for the justification just as it would for any other production. If the justification is an operator application, the result will receive the O-support. Otherwise, the result gets the I-support from the justification. If the result loses the I-support from the justification, it will be retracted if there is no other support. The justification is not added to the production memory, but are otherwise treated as an instantiated production that has already fired. In an embodiment, the justifications include any negated conditions that were in original productions, participated in producing the results, and tested for the absence of super-state element of the working memory.

Further, in the cognitive agent business rules system 114, an impasse of the plurality of impasses is regenerated when the problem solving in a sub-goal becomes inconsistent with a current situation. During problem solving in the sub-goal, the cognitive agent business rules system 114 monitors an aspect of the surrounding situation (the one or more elements of the working memory that exist in super-states) problem solving in the sub-goal has depended upon. If those aspects of the surrounding situation change, either because of changes in input or because of results, the problem solving in the sub-goal is inconsistent, and the state created in response to the impasse is removed and a new state is created. The problem solving continues from this new state. The impasse is not resolved, and the cognitive agent business rules system 114 does not learn in this situation.

In the cognitive agent business rules system 114, in case of multiple sub-states, a cycle followed by the cognitive agent business rules system 114 remains same as when there are no sub-states but has a plurality of changes. The plurality of changes includes a first change and a second change. The first change is that during the decision procedure, the cognitive agent business rules system 114 detects the plurality of impasses and creates new sub-states. The second change when there are multiple sub-states at each phase, the cognitive agent business rules system 114 goes through each of the sub-states, from oldest (highest) to newest (lowest), completing any necessary processing at that level for that phase before performing any processing in the next sub-state. In an embodiment, during firing of the production for the proposal, the cognitive agent business rules system 114 processes the firing (and retraction) of rules, starting from those matching an oldest sub-state to a newest. Further, whenever a production fires or retracts, changes are made to the working memory and the preference memory, possibly changing which productions will match at lower levels. Further, productions firing within a given level are fired in parallel to each other. The productions firings at higher levels resolves the plurality of impasses, thereby eliminate lower states before the productions at the lower level ever fire. Thus, whenever a level in the state stack is reached, all production activity is guaranteed to be consistent with any processing that has occurred at higher levels.

In an embodiment of the present disclosure, the cognitive agent business rules system 114 is capable of learning from experience. A learning mechanism of the cognitive agent business rules system 114 is referred to as chunking. In the chunking, the cognitive agent business rules system 114 creates a new production, called a chunk. Conditions of the chunk are the one or more elements of the state that allowed the plurality of impasses to be resolved; the action of the production is the one or more elements of the working memory or the plurality of preferences that resolved each of the plurality of impasses. The conditions and the action are variablized for matching a new production in a similar situation in future and prevent an impasse from arising

Further, a key concept of the cognitive agent business rules system 114 is that the working memory is a set, meaning that there can never be two elements in the working memory at the same time having a same identifier-attribute value triple. However, it is possible to have multiple working memory elements that have the same identifier and attribute, however each have different values thus forming a multi-attribute. Moreover, the one or more elements in the working memory arise from the plurality of sources. The plurality of sources includes a first source, a second source, a third source and a fourth source. The first source describes that the actions of productions create most of the working memory elements. The second source describes that the decision procedure automatically creates some special state augmentations (for example, type, the super-state, the plurality of impasses and the like) whenever the state is created. The states are created during an initialization (the first state) or due to the impasse (the sub-state). The third source describes that the decision procedure creates an operator augmentation of the state based on the plurality of preferences. This records the selection of the current operator. The fourth source describes that external I/O systems create the working memory elements on the input-link for sensory data.

Further, in the cognitive agent business rules system 114, the one or more elements in working memory are removed by a plurality of removal ways. The plurality of removal ways includes a first way, a second way, a third way, a fourth way, a fifth way and a sixth way. According to the first way, the decision procedure automatically removes all state augmentations it creates when the impasse that led to their creation is resolved. According to the second way, the decision procedure removes the operator augmentation of the state when that operator is no longer selected as the current operator. According to the third way, the actions of the production that uses reject preferences remove working memory elements that were created by other productions. According to the fourth way, the architecture of the cognitive agent business rules system 114 automatically removes the I-supported WMEs when the productions that created them no longer match. According to the fifth way, an I/O system removes sensory data from the input-link when it is no longer valid. According to the sixth way, the architecture of the cognitive agent business rules system 114 automatically removes the WME's that are no longer linked to the state.

Further, the cognitive agent business rules system 114 distinguishes between two types of working memory symbols. The two types of working memory symbols include identifiers and constants. The identifier is a unique symbol, created at runtime when a new object is added to the working memory. Further, there are three types of constants including integers, floating-point, and symbolic constants. For the integers, a range of values depends on the machine and implementation. For the floating-point, range depends on machine and implementation. The symbolic statements are symbols with arbitrary names. A constant can use any combination of letters, digits, special symbols and the like. Further, characters including blank spaces can be included by surrounding the complete constant name with vertical bars.

In the cognitive agent business rules system 114, all the WME's that share an identifier are collectively referred to as the object in the working memory. Further, individual working memory elements that make up the object are referred to as augmentations, as they augment the object. A template for the object in the working memory of the cognitive agent business rules system 114 is described below:

(identifier ̂attribute-1 value-1 ̂attribute-2 value-2 ̂attribute-3 value-3 . . . ̂attribute-n value-n)

For example, the one or more elements in the working memory when running a program may be as follows:

(S1 ̂io I1 ̂ontop O2 ̂ontop O3 ̂ontop O1 ̂problem-space blocks ̂superstate nil ̂thing B3 ̂thing T1 ̂thing B1 ̂thing B2 ̂type state)

In the cognitive agent business rules system 114, when the working memory element is created, the cognitive agent business rules system 114 assigns it a unique integer timetag. The timetag is a part of the working memory element, and therefore, WME's are referred to as quadruples, rather than triples. However, the timetags are not represented in the working memory and cannot be matched by productions. Further, the timetags are used to distinguish between one or more occurrences of the same WME. As the preference changes and elements are added and deleted from the working memory, the WME can be created, removed, and created again. In an embodiment, a second creation of the WME which bears a same identifier, attribute, and value as a first WME is different, and therefore is assigned a different timetag. This is important as a production fires only once for a given instantiation, and the instantiation is determined by timetags that match the production and not by the identifier-attribute-value triples.

In the cognitive agent business rules system 114, the acceptable preferences for the operator augmentations of the states appear in the working memory as the identifier-attribute-value-preference quadruples. No other preferences appear in the working memory. A template for an acceptable preference in working memory is:

(identifier ̂operator value+)

In the cognitive agent business rules system 114, the working memory is not only a set, it is also a graph structure where the identifiers are nodes, the attributes are links, and the constants are terminal nodes. The working memory is not an arbitrary graph, but a graph rooted in the states. Further, all the WMEs are linked either directly or indirectly to the state. An impact of this constraint is that all the WMEs created by the actions are linked to the WMEs tested in the conditions. The link is one-way, from the identifier to the value.

A long term memory of the cognitive agent business rules system 114 is referred to as production memory. The production memory includes productions or rules, which can be loaded in by a use or generated by the chunking. Further, each of the production has three required components including a name, a set of conditions (referred to as left-hand side, or LHS), and a set of actions (referred to as right-hand side, or RHS). Further, there are two optional components including a documentation string and a type. Syntactically, each of the production includes a symbol sp, followed by an opening curly brace (‘{’), a production name, a documentation string (optional),a production type (optional), one or more comments (optional),one or more production conditions, a symbol -->(literally-dash dash-greater than), one or more production's actions; and a closing curly brace(‘}’). Each element of a production is separated by white space. A syntax representing the above statements are:

sp {production-name Documentation string :type CONDITIONS -->ACTIONS }

In the cognitive agent business rules system 114, the name of the production is an almost arbitrary constant. Conventionally, the name of the production describes a role of the production; however functionally, the name is just a label primarily for the use of the programmer. In an embodiment of the present disclosure, the production name can never be a single letter followed by numbers. Further, a convention for naming productions is to separate important elements with asterisks. The important elements that tend to appear in the name include a name of the task or goal (for example, blocks-world), a name of an architectural function (for example, propose), a name of the operator (or other object) at issue. (for example, move-block) and any other relevant details.

In the cognitive agent business rules system 114, the production may contain an optional documentation string. Syntax for the documentation string is that it is enclosed in double quotes and appears after the name of the production and before a first condition (and may carry over to multiple lines). The documentation string allows an inclusion of internal documentation about the production. The production may also include an optional production type, which may specify that the production should be considered a default production (:default) or a chunk (:chunk), or may specify that a production should be given the O-support (:o-support) or the I-support (:i-support). There is an additional flag (:interrupt) that can be placed at this location in the production. However, this flag does not specify the production type, but is a signal that the production should be marked for special debugging capabilities. Further, the productions may contain single line comments which begin with a #.

In the cognitive agent business rules system 114, a condition side of the production includes a set of conditions. Each of the condition tests for the existence or absence of the working memory elements. Further each of the condition includes an open parenthesis, followed by a test for the identifier, and the tests for the augmentations of that identifier, in terms of attributes and values. Moreover, the condition is terminated with a close parenthesis. Thus, a single condition might test properties of the one or more working memory elements that constitute the object. The single condition is described as follows:

(identifier-test ̂attribute1-test value1-test ̂attribute2-test value2-test ̂attribute3-test value3-test)

The first condition in a production must match against the state in the working memory. Further, the first condition must begin with an additional symbol state. All other conditions and actions must be linked directly or indirectly to this condition. In the cognitive agent business rules system 114, variables match against constants in the working memory elements in the identifier, the attribute, or value positions.

In the cognitive agent business rules system 114, in an embodiment of the present disclosure, a test for the identifier, the attribute, or the value in the condition (whether constant or variable) can be modified by a preceding predicate. In an embodiment, number of predicates that can be used are six in number including <>, <=>, <, <=, >= and >. In the cognitive agent business rules system 114, in another embodiment of the present disclosure, a test for the identifier, the attribute, or the value may be for a disjunction of constants. With the disjunction, there is a match if any one of the constants is found in the working memory element (and the other parts of the working memory element matches). Further, variables and the predicates may not be used within disjunctive tests. For example, a third condition of a production contains a disjunction that restricts a color of table to red or blue as follows:

sp {blocks*example-production-conditions (state ̂operator <o>+̂table <t>) (<o> ̂name move-block) (<t> ̂type table ̂color <<red blue >>) -->}

In the cognitive agent business rules system 114, in yet another embodiment of the present disclosure, a test for the identifier, the attribute, or the value in a condition may include a conjunction of tests, all of which must hold for there to be a match. Syntactically, conjuncts are contained within curly braces.

Further, in an addition to positive tests for the one or more elements in the working memory, conditions can also test for an absence of one or more patterns. Moreover, a negated condition is matched only if there does not exist a working memory element which is consistent with its tests and variable bindings. Thus, it is a test for the absence of the working memory element. Further, in the cognitive agent business rules system 114, conditions can be grouped into one or more conjunctive sets by surrounding the set of conditions with ‘{‘and’}’. The production compiler groups the test in these conditions together. This grouping allows for negated tests of more than one working memory element at a time. In the example below, the state is tested to ensure that it does not have the object on the table:

sp {blocks*negated-conjunction-example (state <s> ̂name top-state)-{(<s> ̂ontop<on>) (<on> ̂bottom-object <bo>) (<bo> ̂type table)} --> (<s> ̂nothing-ontop-table true) }

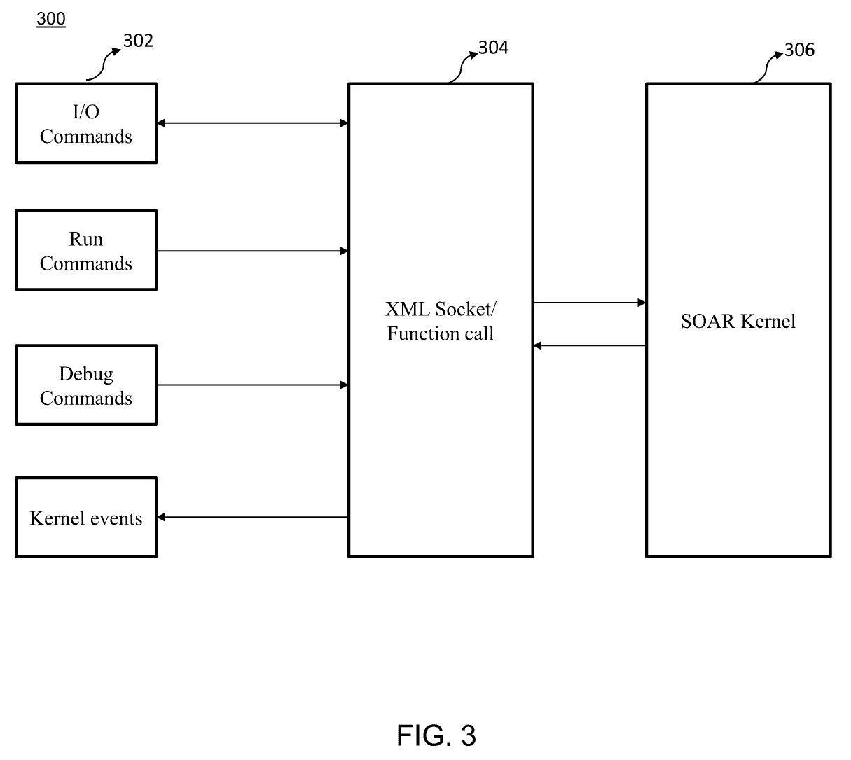

Now referring to FIG. 3, an architecture for implementing a simplified interface to access the cognitive agent business rules system 114 is described in accordance with various embodiments of the present disclosure. A command module 302 configured to send commands such as—I/O commands, run commands, debug commands, kernel events module comprising decision events post agent creation cycle each are identified with a pre-defined syntax. The commands are entered through an interface that receives and parses XML input. In a preferred embodiment of the present disclosure, each of these commands are passed on to the kernel 306 of the cognitive agent business rules system through a socket or a function call using a modified markup language such as XML. The input strings can be sent through an XML client 304 in one or more ways such as through sockets or remote function calls. Since the objects parsed in the XML strings are related to cognitive agent business rules system, the XML strings are referred to as modified XML strings.

The present disclosure provides a cross platform and language independent convention for representing and interacting with objects received in XML commands. This allows the user to use any known programming languages such as C, C++, Java etc. and pass it to the parser as a XML string. Alternatively, a modified XML version called SML functions can be written in the programming language of interest and with the help of XML DOM (document object model), the commands are parsed and passed on to the kernel for execution.

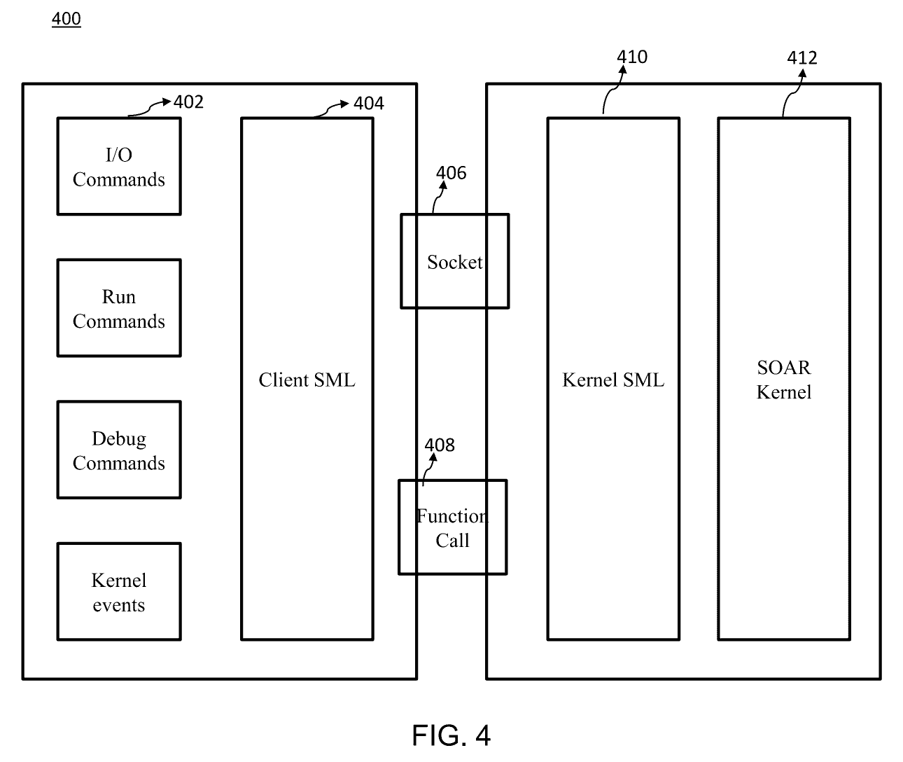

FIG. 4 illustrates another exemplary architecture for implementing an interface to enter commands and access the cognitive agent business rules system 114, in accordance with various embodiments of the present disclosure. As can be seen, command modules 402 are pre-loaded at a client 404. The command module 402 may also provide custom codes for at least for input/output, run commands, debug commands etc. The client 404 is a computer machine providing at least a command line interface to the user for receiving input in the form of modified XML string. A socket 406 or a remote function call 408 transmits the commands—as parsed XML strings to the kernel side. During the parsing step, objects pertaining to the cognitive agent business rules system 114 are added to a document object model (DOM). At the kernel side, the parsed strings are received at a SML kernel 410 for execution whereas the objects pertaining to the cognitive agent are received by the SOAR kernel 412. Further, the architecture as described herein allows the cognitive agent business rules system 114 to handle events over remote connections. The command module 402 provides functionalities such as:
a) adding structures to input link representation:
   Identifier*pInputLink=pAgent->GetInputLink( )
   Identifier* pID =pAgent->CreateIdWME(pInputLink, “plane”) ;
   StringElement*pWME1=pAgent->CreateStringWME(pID, “type”, “Boeing747”)
b) Send changes to kernel:
   pAgent->Commit( );
c) check for output commands;
d) access substructures direct1 and the like.

The modified XML interface for accessing the cognitive agent business rules system 114 also provides additional functionality for connecting the command line input in various programming languages such as C++, Java etc to high level programming languages in the kernel. Further, the functionality provides means for creating and storing custom codes to handle callbacks. Furthermore, the functionality provides integration of programming languages such as Java and tool command languages (TCL).

In an embodiment of the present disclosure, the cognitive agent business rules system 114 is configured to provide control loops for both asynchronous and synchronous environments.

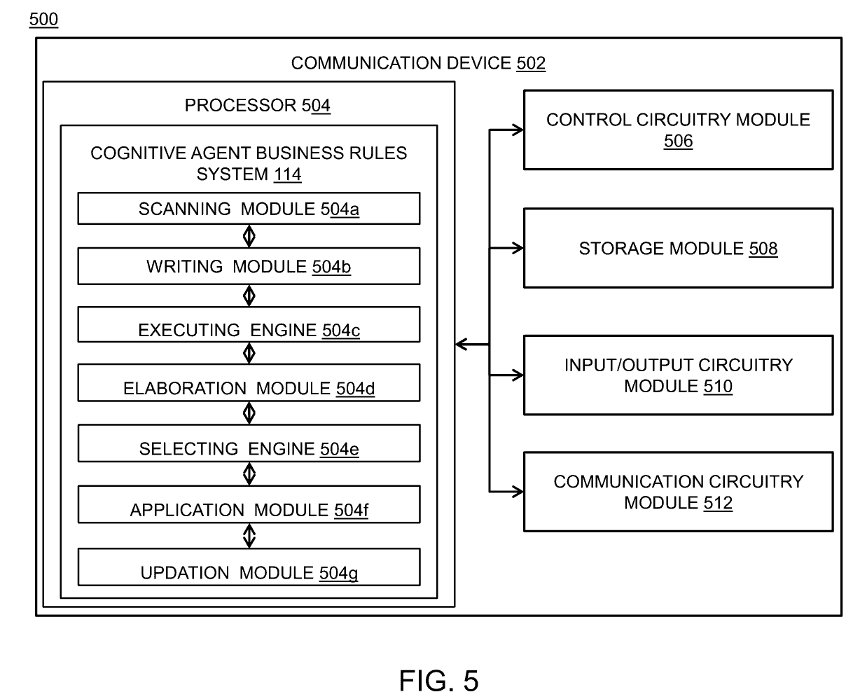

FIG. 5 illustrates a block diagram 500 of a communication device 502, in accordance with various embodiments of the present disclosure. The communication device 502 includes a processor 504, a control circuitry module 506, a storage module 508, an input/output circuitry module 510 and a communication circuitry module 512. The processor 504 runs the cognitive agent business rules system 114. Further, the cognitive agent business rules system 114 includes a scanning module 504a, a writing module 504b, an executing engine 504c, an elaboration module 504d, a selecting engine 504e, an application module 504f and updation module 504g. The above stated components of the processor 504 enable working of the cognitive agent business rules system 114.

The scanning module 504a scans a plurality of elements added to the input link of the initialized state. The state is the top level object. The writing module 504b writes the scanned plurality of elements to the output link of the initialized state. The executing engine 504c executes the plurality of business rules based on creation of the state graph. The state graph is created by adding the plurality of nodes and the plurality of attributes to the top level state. The elaboration module 504d adds the plurality of elaborations to the state graph. The selecting engine 504e selects the one or more operators for execution. The one or more operators are selected based on a preference of the plurality of preferences in the preference memory. The preference is an imperative associated with an operator of the one or more operators. The application module 504f applies the actions of productions on the operator of the one or more operators. The actions of productions can be applied by adding and removing the elements. The updation module 504g updates the state graph. The state graph is updated to reflect a new state of the state graph.

The tasks performed by the scanning module 504a, the writing module 504b, the executing engine 504c, the elaboration module 504d, the selecting engine 504e, the application module 504f and the updation module 504g of the cognitive agent business rules system 114 are executed using one or more commands in the Java implementation of the Soar agent. Each of these one or more commands are now described in detail.

The plurality of functions implemented by the Soar agent include but are not limited to the soar debugger, soar scripting, soar commands, soar input/output, soar events etc. The executing engine 504c provides a Soar debugger is a graphical interface for debugging the Soar agents one at a time. The debugger provides plurality of views in separate dockable windows within the main debugger window. Each view provides a different set of information about the agent being debugged. Most views are shown by default and other, less commonly used views can be opened through the View menu. Further, many views are driven by selection. That is, selection an item in one view will cause another view to update its contents. Few examples of the debugger window views include Trace view, Production view, Goal stack view, Match set view, WME support view, WME search view, preferences view etc. The Trace view shows the trace of the agent's execution, output of commands executed, using trace text to view WME selection and the like.

In an embodiment of the present disclosure, the writing module 504b in JSoar uses a web-based debugging interface referred to as Legilimens. Once enabled, it starts a lightweight web server through for monitoring and debugging. Further, the Legilimens can be used to View the agent trace, execute commands, view and edit production, inspect working memory and the like. In an embodiment of the present disclosure, the JSoar includes a plurality of RHS functions including debug, wait, get-url<url>, to-xml <id>, from-xml <xml>and split <string><regex>. The debug opens a debugger for an agent. The wait causes the agent's thread to sleep until new input is available. The get-url<url>retrieves the contents of a given URL (a string) and return it as a string. The to-xml <id>converts the working memory under a given id into XML and returns it as a string. The from-xml <xml>converts the given XML string to working memory and returns an identifier. The split <string><regex>splits a string with a given regular expression and returns a linked-list of strings.

In an embodiment of the present disclosure, the application module 504f of the JSoar implementation includes one or more specific commands. The one or more specific commands include properties, rhs-functions, qmemory, log, handler and the like. In an embodiment of the present disclosure, one or more methods are utilized to provide an input to a JSoar agent. The one or more methods can be used interchangeably and may be used in a mixed way. In an embodiment, a method of the one or more methods is chosen based on performance needs and length of code to be typed.

Going further, in the cognitive agent business rules system 114, Legilimens is a web-based debugging interface for the JSoar agents. The Legilimens starts a lightweight web server once enabled for monitoring and debugging agents. Moreover, the web-based debugging interface is provided for viewing agent trace, execute one or more commands, viewing and editing production, inspecting working memory and the like. In addition, jsoar-Legilimens.jar must be on class path for using the Legilimens. The Legilimens is only compatible with ThreadedAgent-based systems. Further, raw Agent does not provide concurrency guarantees required to build an effective general debugging interface.

In an embodiment of the present disclosure, a function org.jsoar.Legilimens.LegilimensServer.start( ) is called to enable the Legilimens. The Legilimens automatically detect new agents and hook into the new agents when needed. In an embodiment of the present disclosure, the JSoar includes provides a log command for writing information to the trace and optionally, to an SLF4J-compatible logging implementation. The log command is used for improving and combining an echo command and the write RHS function.

In an embodiment of the present disclosure, the JSoar includes convenience classes that allow users to listen for specific types of WMEs that appear on the output link. Moreover, the JSoar has a built-in support for automatically converting the working memory to Java object, called SoarBeans. The basic idea is to define a Java class, the bean, and register an output command handler with the SoarBeanOutputManager. When an output command is detected, the Soar working memory elements are converted to an instance of the class and passed to a handler method provided. In addition, the Soar has a built-in support for reading “command”-style WMEs that appear on the output link.

In an embodiment of the present disclosure, the JSoar includes one or more built-in RHS functions. The one or more built-in RHS functions include debug, wait, get-url<url>, to-xml <id>, from-xml <xml>, split <string><regex>, e, pi, max <a>, min <a>, list 1 2 3 4, format <format-string><args . . . >, log and the like. In an embodiment of the present disclosure, the JSoar has a built-in support for implementing simple environments by embedding Javascript, Python or Ruby code directly in soar source files. The JSoar scripting is used for implementing simple agent environments, quickly implement new RHS functions, generating I/O for tests and implement simple custom user interfaces for agents.

Further, the JSoar includes one or more system properties for controlling behavior of the JSoar. The one or more system properties include but may not be limited to jsoar.agent.interpreterjsoar.do_top_level_ref_ctsjsoar.o_rejects_firstjsoar.debugger.provider, jsoar.discardVarNames and jsoar.warnOnJavaSymbols. System properties are used by the jSoar to pass the arguments to Soar agent. The system properties as described herein also corresponds to pre-processor macros in C implementation of Soar.

Further, the JSoar component is configured to provide for episodic memory. For example, a WME with an attribute not in the inclusion list may still be included in the episode if that WME's value is an identifier which, somewhere in the subgraph rooted at that identifier, there is an attribute in the inclusion list. For example, if the inclusion list contains only the attribute “keep” and WM looks like this:
(<s>̂test <test>
   ̂stuff <stuff>)
(<test>̂test 4)
(<stuff>̂keep <this>
̂do-not-keep <that>)
then episodic memory will only record this path: (<s>̂stuff.keep<this>)

In an embodiment of the present disclosure, the Soar agent includes a centralized event system with which listeners can be registered and events can be received. Important interfaces are SoarEventManager and SoarEventListener. Client code implements the SoarEventListener interface and registers with the SoarEventManager, which is accessible through agent.getEvents( )

The Soar agent of the cognitive agent business rules system 114 provides a plurality of input means. The input mechanism is based on a core API which is used to provide quick input as well as input to WMEs (inputWME). An input event is triggered whenever the state graph enters an input phase. The Soar agent further comprises an ‘InputBuilder’ that provides a builder like interface for providing input during working memory constructions. In an embodiment, the ‘InputBuilder’ interface is also configured to use helper methods for creating input WMEs and symbols.

In one embodiment of the present disclosure, the Soar agent provides means for implementing simple environments by executing Javascript, Ruby code, Python script etc. This enables the user to generate simple I/O for testing Soar agent. Further, the provision for scripting in Soar agent allows implementation of new RHS functions as well as custom interfaces for users. The scripting API also provides commands for exposing the Soar agent and obtaining all the functions. RHS functions (discussed elsewhere) can also be installed by initializing the scripting engine.

Java implementation of the Soar agent further provides a ‘Print’ command. This command is used to print the information to trace view of the debugger. Further, the print command allows the user to print messages to trace view. A Writer or Printwriter command is used to customize the output destination of the Printer. The trace command is further configured to filter the arguments passed by the Print writer based on one or more categories defined on the log levels such as debugger, error, info, warning etc.

Output command in the Java implementation of the Soar agent triggers the WMEs to be converted into instance of the designated class are further passed to an handler. In one embodiment of the present disclosure, writing a full Java bean class is avoided by providing quick one-off command registration APIs. After registering the Output Event, a wmes.matcher( ) extracts the data from output command WMEs whenever the event is triggered. These and other commands used in the Java implementation of the Soar agent will now be described using examples as described below.

The communication device 502 includes any suitable type of portable electronic device. Examples of the communication device 502 include but may not be limited to a high end laptop computer, a tablet computer, desktop computer, and a server having computational capabilities.

From the perspective of this disclosure, the control circuitry module 506 includes any processing circuitry or processor operative to control the operations and performance of the communication device 502. For example, the control circuitry module 506 may be used to run operating system applications, firmware applications, media playback applications, media editing applications, or any other application. In an embodiment, the control circuitry module 506 drives a display and process inputs received from a user interface.

From the perspective of this disclosure, the storage module 508 includes one or more storage mediums including a hard-drive, solid state drive, flash memory, permanent memory such as ROM, any other suitable type of storage component, or any combination thereof. The storage module 508 may store, for example, media data (e.g., music and video files), application data (e.g., for implementing functions on the communication device 502).

From the perspective of this disclosure, the I/O circuitry module 510 may be operative to convert (and encode/decode, if necessary) analog signals and other signals into digital data. In an embodiment, the I/O circuitry module 510 may also convert the digital data into any other type of signal and vice-versa. For example, the I/O circuitry module 510 may receive and convert physical contact inputs (e.g., from a multi-touch screen), physical movements (e.g., from a mouse or sensor), analog audio signals (e.g., from a microphone), or any other input. The digital data may be provided to and received from the control circuitry module 506, the storage module 508 or any other component of the communication device 502.

From the perspective of this disclosure, the I/O circuitry module 510 may be operative to convert (and encode/decode, if necessary) analog signals and other signals into digital data. In an embodiment, the I/O circuitry module 510 may also convert the digital data into any other type of signal and vice-versa. For example, the I/O circuitry module 510 may receive and convert physical contact inputs (e.g., from a multi-touch screen), physical movements (e.g., from a mouse or sensor), analog audio signals (e.g., from a microphone), or any other input. The digital data may be provided to and received from the control circuitry module 506, the storage module 508 or any other component of the communication device 502.

From the perspective of this disclosure, the I/O circuitry module 510 may be operative to convert (and encode/decode, if necessary) analog signals and other signals into digital data. In an embodiment, the I/O circuitry module 510 may also convert the digital data into any other type of signal and vice-versa. For example, the I/O circuitry module 510 may receive and convert physical contact inputs (e.g., from a multi-touch screen), physical movements (e.g., from a mouse or sensor), analog audio signals (e.g., from a microphone), or any other input. The digital data may be provided to and received from the control circuitry module 506, the storage module 508 or any other component of the communication device 502.

It may be noted that the I/O circuitry module 510 is illustrated in FIG. 5 as a single component of the communication device 502; however those skilled in the art would appreciate that several instances of the I/O circuitry module 510 may be included in the communication device 502.

The communication device 502 may include any suitable interface or component for allowing the user 102 to provide inputs to the I/O circuitry module 510. The communication device 502 may include any suitable input mechanism. Examples of the input mechanism include but may not be limited to a button, keypad, dial, a click wheel, and a touch screen. In an embodiment, the communication device 502 may include a capacitive sensing mechanism, or a multi-touch capacitive sensing mechanism.

In an embodiment, the communication device 502 may include specialized output circuitry associated with output devices such as, for example, one or more audio outputs. The audio output may include one or more speakers built into the communication device 502, or an audio component that may be remotely coupled to the communication device 502.

The one or more speakers can be mono speakers, stereo speakers, or a combination of both. The audio component can be a headset, headphones or ear buds that may be coupled to the communication device 502 with a wire or wirelessly.

In an embodiment, the I/O circuitry module 510 may include display circuitry for providing a display visible to the user 102. For example, the display circuitry may include a screen (e.g., an LCD screen) that is incorporated in the communication device 502.

The display circuitry may include a movable display or a projecting system for providing a display of content on a surface remote from the communication device 502 (e.g., a video projector). In an embodiment, the display circuitry may include a coder/decoder to convert digital media data into the analog signals. For example, the display circuitry may include video Codecs, audio Codecs, or any other suitable type of Codec.

The display circuitry may include display driver circuitry, circuitry for driving display drivers or both. The display circuitry may be operative to display content. The display content can include media playback information, application screens for applications implemented on the electronic device, information regarding ongoing communications operations, information regarding incoming communications requests, or device operation screens under the direction of the control circuitry module 506. Alternatively, the display circuitry may be operative to provide instructions to a remote display.

In addition, the communication device 502 includes the communication circuitry module 512. The communication circuitry module 512 may include any suitable communication circuitry operative to connect to a communication network and to transmit communications (e.g., voice or data) from the communication device 502 to other devices within the communications network. The communication circuitry module 512 may be operative to interface with the communication network using any suitable communication protocol. Examples of the communication protocol include but may not be limited to Wi-Fi, Bluetooth™, radio frequency systems, infrared, LTE, GSM, GSM plus EDGE, CDMA, and quadband.

In an embodiment, the communication circuitry module 512 may be operative to create a communications network using any suitable communications protocol. For example, the communication circuitry module 512 may create a short-range communication network using a short-range communications protocol to connect to other devices. For example, the communication circuitry module 512 may be operative to create a local communication network using the Bluetooth™, protocol to couple the communication device 502 with a Bluetooth™, headset.

It may be noted that the computing device is shown to have only one communication operation; however, those skilled in the art would appreciate that the communication device 302 may include one more instances of the communication circuitry module 512 for simultaneously performing several communication operations using different communication networks. For example, the communication device 502 may include a first instance of the communication circuitry module 512 for communicating over a cellular network, and a second instance of the communication circuitry module 512 for communicating over Wi-Fi or using Bluetooth™.

In an embodiment, the same instance of the communication circuitry module 512 may be operative to provide for communications over several communication networks. In an embodiment, the communication device 502 may be coupled to a host device for data transfers, synching the communication device 502, software or firmware updates, providing performance information to a remote source (e.g., providing riding characteristics to a remote server) or performing any other suitable operation that may require the communication device 502 to be coupled to a host device. Several computing devices may be coupled to a single host device using the host device as a server. Alternatively or additionally, the communication device 302 may be coupled to the several host devices (e.g., for each of the plurality of the host devices to serve as a backup for data stored in the communication device 302).

It may be noted that in FIG. 5 various modules of the cognitive agent business rules system 114 are shown; however those skilled in the art would appreciate that the cognitive agent business rules system 114 may have more/less number of modules.

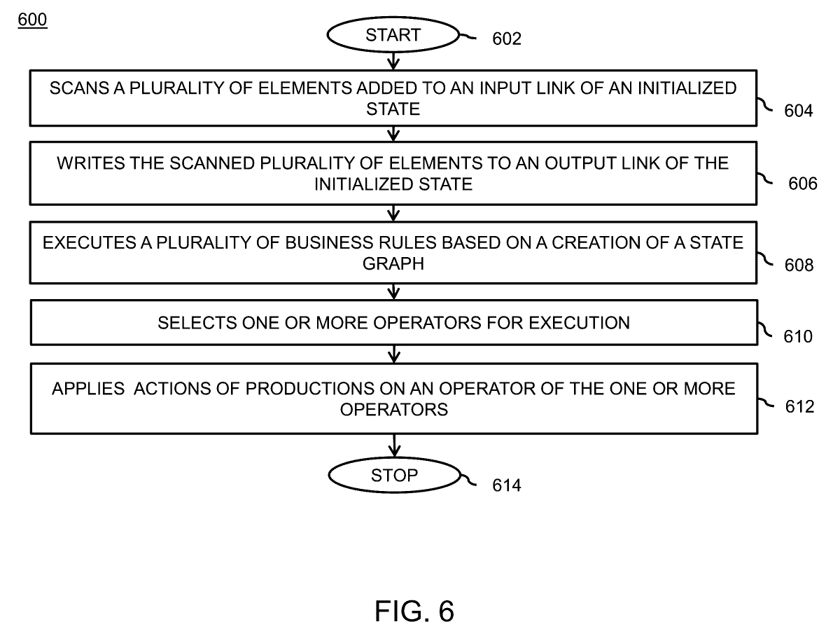

FIG. 6 is a flowchart 600 describing the execution of the plurality of business rules by the cognitive agent business rules system 114, in accordance with various embodiments of the present disclosure. It may be noted that to explain various process steps of FIG. 6, references will be made to the system elements of FIG. 1A, FIG. 2 and FIG. 3. The flowchart 600 initiates at step 602. Following step 602, at step 604, the cognitive agent business rules system 114 scans the plurality of elements added to the input link of the initialized state. The state is the top level object. At step 606, the cognitive agent business rules system 114 writes the scanned plurality of elements to the output link of the initialized state. At step 608, the cognitive agent business rules system 114 executes the plurality of business rules based on the creation of the state graph. The state graph is created by adding the plurality of nodes and the plurality of attributes to the top level state. At step 610, the cognitive agent business rules system 114 selects the one or more operators for execution. The one or more operators are selected based on a preference of the plurality of preferences in the preference memory. The preference is the imperative associated with an operator of the one or more operators. At step 612, the cognitive agent business rules system 114 applies the actions of productions on an operator of the one or more operators. The actions of productions can be applied by adding and removing the elements. The flowchart 600 terminates at step 614.

It may be noted that the flowchart 600 is explained to have above stated process steps; however, those skilled in the art would appreciate that the flowchart 600 may have more/less number of process steps which may enable all the above stated embodiments of the present disclosure.

While the disclosure has been presented with respect to certain specific embodiments, it will be appreciated that many modifications and changes may be made by those skilled in the art without departing from the spirit and scope of the disclosure. It is intended, therefore, by the appended claims to cover all such modifications and changes as fall within the true spirit and scope of the disclosure.

What is claimed is:

1. A computer-implemented method comprising:
scanning, with a processor, a plurality of elements added to an input link of an initialized state, wherein the state being a top level object;
writing, with the processor, the scanned plurality of elements to an output link of the initialized state;
executing, with the processor, a plurality of business rules based on creation of a state graph, wherein the state graph being created by adding a plurality of nodes and a plurality of attributes to a top level state;
selecting, with the processor, one or more operators for execution, wherein the one or more operators being selected based on a preference of a plurality of preferences in a preference memory, wherein the preference being an imperative associated with an operator of the one or more operators; and
applying, with the processor, actions of production on an operator of the one or more operators, wherein the actions of production can be applied by adding and removing an element of the plurality of elements.

2. The computer-implemented method as claimed in claim 1, further comprising adding, with the processor, a plurality of elaborations to the state graph, wherein the adding being performed prior to the selecting of the one or more operators for execution.

3. The computer-implemented method as claimed in claim 1, further comprising updating, with the processor, the state graph, wherein the state graph being updated to reflect a new state of the state graph.

4. The computer-implemented method as claimed in claim 1, wherein each of the plurality of preferences comprises a corresponding semantic of a plurality of semantics, and wherein the plurality of preferences comprises at least one of an acceptable preference, a reject preference, a better/worse preference, a best preference, a worst preference, an indifferent preference, a numeric-indifferent preference, a require preference and a prohibit preference.

5. The computer-implemented method as claimed in claim 4, wherein a plurality of impasses arises from the plurality of preferences, wherein the plurality of impasses comprises a tie impasse, a conflict impasse, a constraint-failure impasse and a no-change impasse, wherein the no-change impasse further comprises a state no-change impasse and an operator no-change impasse.

6. The computer-implemented method as claimed in claim 1, wherein each of the actions of the production adds the plurality of elements in a working memory, and wherein the plurality of elements being added from at least one of a plurality of sources.

7. The computer-implemented method as claimed in claim 1, wherein each of the actions of the production removes the plurality of elements from a working memory, and wherein the plurality of elements being removed by at least one of a plurality of removal ways.

8. The computer-implemented method as claimed in claim 1, wherein one or more variables being bound to one or more symbols in the corresponding plurality of elements of a working memory to obtain a production.

9. A computer program product comprising a non-transitory computer readable medium storing a computer readable program, wherein the computer readable program when executed on a computer causes the computer to perform steps comprising:
scanning a plurality of elements added to an input link of an initialized state, wherein the state being a top level object;
writing the scanned plurality of elements to an output link of the initialized state;
executing a plurality of business rules based on creation of a state graph, wherein the state graph being created by adding a plurality of nodes and a plurality of attributes to a top level state;
selecting one or more operators for execution, wherein the one or more operators being selected based on a preference of a plurality of preferences in a preference memory, wherein the preference being an imperative associated with an operator of the one or more operators; and
applying actions of production on an operator of the one or more operators, wherein the actions of production can be applied by adding and removing an element of the plurality of elements.

10. The computer program product as claimed in claim 9, wherein the computer readable program when executed on the computer causes the computer to perform a further step of adding, with the processor, a plurality of elaborations to the state graph, wherein the adding being performed prior to the selecting of the one or more operators for execution.

11. The computer program product as claimed in claim 9, wherein the computer readable program when executed on the computer causes the computer to perform a further step of updating the state graph, wherein the state graph being updated to reflect a new state of the state graph.

12. The computer program product as claimed in claim 9, wherein each of the plurality of preferences comprises a corresponding semantic of a plurality of semantics, and wherein the plurality of preferences comprises at least one of an acceptable preference, a reject preference, a better/worse preference, a best preference, a worst preference, an indifferent preference, a numeric-indifferent preference, a require preference and a prohibit preference.

13. The computer program product as claimed in claim 12, wherein a plurality of impasses arises from the plurality of preferences, wherein the plurality of impasses comprises a tie impasse, a conflict impasse, a constraint-failure impasse and a no-change impasse, wherein the no-change impasse further comprises a state no-change impasse and an operator no-change impasse.

14. The computer program product as claimed in claim 9, wherein each of the actions of the production adds the plurality of elements in a working memory, and wherein the plurality of elements being added from at least one of a plurality of sources.

15. The computer program product as claimed in claim 9, wherein each of the actions of the production removes the plurality of elements from a working memory, and wherein the plurality of elements being removed by at least one of a plurality of removal ways.

16. A cognitive agent business rules system comprising:
a scanning module, in a processor, wherein the scanning module, being configured to scan a plurality of elements added to an input link of an initialized state, wherein the state being a top level object;
a writing module, in the processor, wherein the writing module being configured to write the scanned plurality of elements to an output link of the initialized state;
an executing engine, in the processor, wherein the executing engine being configured to execute a plurality of business rules based on creation of a state graph, wherein the state graph being created by adding a plurality of nodes and a plurality of attributes to a top level state;
a selecting engine, in the processor, wherein the selecting engine being configured to select one or more operators for execution, wherein the one or more operators being selected based on a preference of a plurality of preferences in a preference memory, wherein the preference being an imperative associated with an operator of the one or more operators; and
an application module, in the processor, wherein the application module being configured to apply actions of production on an operator of the one or more operators, wherein the actions of production can be applied by adding and removing an element of the plurality of elements.

17. The cognitive agent business rules system as claimed in claim 16, further comprising an elaboration module, in the processor, wherein the elaboration module being configured to add a plurality of elaborations to the state graph.

18. The cognitive agent business rules system as claimed in claim 16, further comprising an updation module, in the processor, wherein the updation module being configured to update the state graph, wherein the state graph being updated to reflect a new state of the state graph.

19. The cognitive agent business rules system as claimed in claim 16, wherein each of the plurality of preferences comprises a corresponding semantic of a plurality of semantics, and wherein the plurality of preferences comprises at least one of an acceptable preference, a reject preference, a better/worse preference, a best preference, a worst preference, an indifferent preference, a numeric-indifferent preference, a require preference and a prohibit preference.

20. The cognitive agent business rules system as claimed in claim 19, wherein a plurality of impasses arises from the plurality of preferences, wherein the plurality of impasses comprises a tie impasse, a conflict impasse, a constraint-failure impasse and a no-change impasse, wherein the no-change impasse further comprises a state no-change impasse and an operator no-change impasse.
